(19) United States
(12) Patent Application Publication
(10) Pub. No.: US 2004/0225383 A1
(43) Pub. Date: Nov. 11, 2004

(54) Method for Design of Multi-objective Robust Controllers

(75) Inventors: Kuen-Yu Tsai, Stanford, CA (US); Haitham A. Hindi, Menlo Park, CA (US)

Correspondence Address: KUEN-YU TSAI, 334 OLMSTED ROAD #119 (STUDIO 6), STANFORD, CA, 94305, US

(73) Assignee: STANFORD UNIVERSITY, Palo Alto, CA (US)

(21) Appl. No.: 10/709,458

(22) Filed: May 6, 2004

Related U.S. Application Data
(60) Provisional application No. 60/468,349, filed on May 6, 2003.

(51) Int. Cl. G05B 13/02

(52) U.S. Cl. 700/29

(57) ABSTRACT

A method for design of a multi-objective least conservative robust controller to control a plant or a process which may be modeled imperfectly. It comprises a robust analysis step and a robust multi-objective controller synthesis step using Q-parameterization control design technique. In one embodiment of the invention, the K-step of standard D-K iteration for mu-synthesis is replaced by a Q-parameterization control design step. The Q-step optimization problem formulation comprises a standard robustness measure and one or a plurality of other performance measures. During the iteration, the Q-step optimization problem formulation can be changed. In another embodiment, a controller satisfying a level of robustness measure is first found. Then, a Q-parameterization control design step is performed, such that one or plurality of the other performance measures are optimized, while still satisfying a level of robustness measure which is the same with, or slightly traded-off from the previous level of robustness measure. In all embodiments of the invention, if the robustness measure in the Q-step is formulated based on frequency-gridding, the problematic D-step curve fitting process in standard D-K iteration can be avoided. In addition, a least-conservative non-parametric plant uncertainty weights can incorporated directly without curve-fitting. Therefore the difficulties of curve-fitting and the conservativeness due to curve-fitting in standard D-K iteration can both be eliminated.

### CROSS REFERENCE To RELATED APPLICATIONS

This application claims the benefit of PPA Ser. No. 60/468,349, filed on May 6, 2003 by the present inventors.

### FEDERAL RESEARCH STATEMENT

The work was supported by National Science Foundation with contract ECS-0000541, and DARPA with contract F33615-99-C-3014. Stanford University should hold the patent rights.

### BACKGROUND OF INVENTION

1. The Field of the Invention

This invention relates to the field of robust control engineering, specifically to the design of robust controllers that can make the overall system performance less sensitive to the model imperfection of system under control. Some of the related fields include 700/28, 700/29, and 700/38.

2. Background Information

Robustness is an important issue in many engineering disciplines. In the field of control engineering, robustness against disturbances and model uncertainty is at the heart of control practice. The key part of robust feedback control has been focusing on the effects of plant modeling uncertainty on stability. This is in contrast with optimal control, which usually deals with disturbance rejection while assuming the absence of modeling error. Robust optimal control is a combination of the two, which can keep certain level of disturbance rejection despite the presence of modeling error. If a control design is optimized only for a nominal model without considering possible modeling error, it can perform far from expectation, since the actual system dynamics is not represented exactly by the nominal model. Conversely, it a control design is optimized only for maximizing a stability margin without considering the magnitude and inherent structure of the actual modeling error, the resulting system performance can be over conservative, since the actual system dynamics variation is not as large as modeled in the control design stage. In addition, if performance specifications can not be directly specified in the control design problem formulation, it is impractical to expect the resulting system performance can be meet the specifications.

For designing a controller satisfying some robust stability measures, the D-K iteration method is a widely-adopted approach. D-K iteration was first proposed in the early 80's. One of the key publications is [J. Doyle, “Analysis of feedback systems with structured uncertainties,” IEE Proceedings, 129(6), part D, November 1982]. Some prior-art publications that explain D-K iteration in details of includes [S. Skogestad et al, Multivariable Feedback Control, John 1996][K. Zhou, Essentials of Robust Control, Prentice Hall, 1998][G. Balas et al, μ-Analysis and Synthesis Toolbox, version 3, The Mathworks, Inc., 1998][R. Sanchez-Pena et al, Robust Systems Theory and Applications, 1998]. It starts with defining a general control problem formulation as shown in FIG. 1, where P is a generalized plant model containing a nominal plant model, one or multiple model uncertainty weighting filters to describe the variation of plant uncertainties at different frequencies, and one or multiple selected performance weighting filters to adjust the performance level of the system; K is a controller to be designed; and Δ represents the dynamics of plant variation. For some system performance measures, such as the H_{∞} norm, the robust optimal control problem can be formulated as a augmented robust stability as shown in FIG. 1B, where Δₚ represents some fictitious uncertainty for the performance channel, from the exogenous input w to the exogenous output z. System 110, which is same with system 120 denoted by Δₐ, is a resulting uncertainty system by augmenting Δₚ to Δ. In D-K iteration, a frequency-vary block-diagonal scaling D in FIG. 1C is used in its D-step to exploit the structure of the augmented uncertainty Δₐ.

Thus it can result in a robustly stable system without trading-off too much performance.

A typical D-K iteration procedure can be shown with the example flowchart in FIG. 3. In step 310, a generalized plant model is defined, which represent the interconnections between a provided nominal plant model, the models of one or multiple provides performance weighting filters, and the structure of plant uncertainties. In step 320, a parametric model of the uncertainty weighting filter denoted by W_{del} is provided. It can be an assumed variation, or it can be estimated from a set of experimental data which captures the actual variation of the system. After step 310 and step 320, a general control problem is formulated with all modeling data required for the following steps. Step 330 initializes the iteration by assigning a initial value D₀ the block-diagonal uncertainty scaling D in FIG. 1C. A common choice of D₀ is a block-diagonal identity matrix. In step 330 and step 350, a robustness measure, usually an upper bound of a structured singular valued denoted by μ, is minimized with respect to the controller K, while holding D fixed. Explanations of μ and its upper bound related to H_{∞} norm are explained in many of the prior art publications, such as [A. Packard et al “Linear, multivariable robust control with a μ perspective,” ASME J. of Dynamics, measurement, and Control, vol. 115 June 1993, pp. 426-438]. A robustness measure can also be specified with L₁ norm other than μ, as described in [A. Dahleh et al, Control of Uncertain Systems, 1996]. In common practices, μ is selected as the robustness measure. With this selection, in step 330 and step 350, K is solved as an optimal H_{∞} controller, commonly by using state space approaches such as J. Doyle et al “State-space solutions to standard H₂ and H₂₈ control problems,” IEEE Transactions on Automatic Control, 34(8): 831-847, 1989][P. Gahinet et al “A linear matrix inequality approach to H_{∞} control,” International J. Robust Nonlinear Control, (4)421-448, 1994]. The first is a state-space approach based on a set of Riccati equations, and the second is a generalized of the first by linear matrix equalities. In step 340, the D is commonly computed by first optimizing the frequency response of D at each of a set of selected frequencies independently, based on frequency gridding optimization. However, the state-space approaches in step 350 require parametric models as input data, therefore in step 340, the frequency response of D needs to be curve-fitted to be used in step 350. Similarly, in step 320 parametric models of the plant uncertainty weight W_{del} needs to be provided by curve-fitting the experimental data, usually the frequency response of W_{del}. Step 340, common referred as D-step, and step 350, common referred as K-step, are iterated until a stopping criterion is met. Common stopping criterions includes the selected robustness measure being smaller than a desired value, or the robustness measure not decreasing with more iterations.

There are several issues with the D-K iteration method. First, the requirement of curve-fitting in the step 320 for Wdel and step 340 for D can be problematic. When the frequency response of Wdel or D is complicated, it is hard to curve-fit an accurate parametric model. This can easily cause the designed controller be over conservative. In addition, the error of the D curve-fitting in each D-K iteration can cause the upper bound of μ be increasing in practice. It is also possible that when attempting to use a higher-order model to improve the curve-fitting fidelity, numerical problems such as ill-conditioning can occur.

Second, it is hard to directly incorporate multiple, especially time domain specifications into the D-K iteration design method. Time domain specifications, such as the rise time, the peak step response overshoot, and the peak control effort, etc., are very important for practical control systems. However, D-K iteration, along with most other well-known control design approaches (e.g. P-I-D control, lead-lag control, and LQG method,) can not take these specifications into account directly. The common practice is trying to tune “weighting filters” to meet specifications indirectly. It can be a very long and iterative process if there are many specifications imposed together. In addition, the use of a single H∞ norm to measure the system performance is usually over-simplified. Practical performance specifications are usually specified on different input-output channels, thus using a single system norm to approximate them can easily lead to performance over-conservatism. The state-space approach based on linear matrix equalities does allow multiple controller design constrains to be incorporated together, however in many cases some constraints on the decision variables need to be imposed such that the overall optimization problem is still convex, as shown in [P. Gahinet, et al. LMI Control Toolbox. The Mathworks, Inc, 1995]. Therefore it can easily lead to performance over-conservatism.

Since late 80's and early 90's, Q-parameterization design method has been widely applied to design controllers that can incorporate multiple time-domain and frequency-domain performance specifications. Some of the prior-art publications include [B. Rafaely et al, “H₂/H_{∞} active control of sound in a headrest: design and implementation,” IEEE Trans. Control System Technology, vol. 7, no. 1, January 1999][P. Titterton, “Practical method for constrained-optimization controller design: H or H optimization with multiple H₂ and/or H_{∞} constraints,” IEEE Proceedings of ASILO 1996][P. Titterton, “Practical multi-constraint H controller synthesis from time-domain data,” International J. of Robust and Nonlinear Control, vol. 6, 413-430, 1996][S. P. Wu et al, “FIR filter design via spectral factorization and convex optimization,” in Applied Computational Control, Signal and Communications, 1997][K. Tsai et al, “DQIT: μ-synthesis without D-Scale Fitting,” American Control Conference 2002, pp. 493-498][S. Boyd et al, Linear Controller Design: Limits of Performance. PrenticeHall, 1991] and [S. Boyd et al, “A new CAD method and associated architectures for linear controllers,” IEEE Transactions on Automatic Control, vol.33, p.268, 1988]. FIG. 1D and FIG. 1E show that after Q-parameterization, the new free controller design parameter becomes Q. The method starts with transforming the generalized control design problem formulation in P and K of FIG. 1A to a new form as shown in FIG. 1E, in general using a technique known as Q-parameterization or Youla-parameterization. FIG. 1D shows the structure of Q-parameterization, where a stabilizer J stabilize the system, and the equalizer Q is used to adjust the system response without causing instability, as long as Q itself is stable. The system 210, which is the combination of P and J, is equivalent to the system N in FIG. 1E. Once the design problem has been transformed to the form in FIG. 1E, it can be shown that in the frequency domain, the exogenous output z is related to the exogenous input w as z=(N_{zw}+N_{zy}QN_{uw})w, where N_{zw} is the sub-part of N transferring from w to z, N_{z y} is the sub-part of N transferring from y to z, and N_{u w} is the sub-part of N transferring from w to u. The important aspect is that at each frequency, the equalized, closed-loop transfer matrix from w to z is (N_{zw}+N_{zy}QN_{uw}), which is convex in terms of the frequency response of Q at the same frequency, the equalizer to be designed. Therefore, frequency-shaping specifications and the tradeoff between different input-output channels can be specified as convex objectives and convex constraints when formulating a multi-objective optimization problem. In addition, the frequency response data of N_{zw}, N_{zy}, and N_{uw} can be zw zy uw incorporated without curve-fitting them first. However, plant uncertainties are commonly approximated with a H_{∞} norm constraint without exploiting their inherent conservatism. This can easily lead to performance over-conservatism.

Therefore, what is desired is combine the strength of the D-K iteration method which is the capability to exploit the structure of uncertainties, and the strength of the Q-parameterization method which is the capability to incorporate multiple performance objectives. The invention involves with applying Q-parameterization to FIG. 1A, and thus transforming the robust control design problem formulation from the Δ-P-K form in FIG. 1A, to the Δ-N-Q form in FIG. 2B. The embodiments of the invention provide the capability to synthesize a controller with multiple performance objectives, while satisfying a robustness measure which considers the inherent structure of uncertainties. In addition, the control optimization problem can be formulated based on frequency gridding, such that the numerical problems and conservatisms associated to the curve-fitting of uncertainty scaling in step 340 and the curve-fitting of plant uncertainty weight in step 320 can be avoided.

Some of the related prior-work close to this invention include [A. Lanzon et al “A Frequency Domain Optimisation Algorithm for Simultaneous Design of Performance Weights and Controllers in mu-Synthesis”, Proceedings of the 38th IEEE Conference on Decision and Control, Vol. 5, pp. 4523-4528, Phoenix, Ariz., USA, December 1999][A. Lanzon, “A State-Space Algorithm for the Simultaneous Optimisation of Performance Weights and Controllers in muSynthesis”, Proceedings of the 39th IEEE Conference on Decision and Control, Vol. 1, pp. 611-616, Sydney, Australia, December 2000][A Lanzon, Ph.D. Thesis: “Weight Selection in Robust Control: An Optimisation Approach”, University of Cambridge, UK, October 2000]. In short these prior-art publications are denoted by [Lanzon CDC1999], [Lanzon CDC2000], [Lanzon PhD 2000]. In [Lanzon CDC1999], a control design problem is formulated equivalently to the Δₐ-N-Q form in FIG. 2C to solve a μ-synthesis problem by iterating a D-step without D-fitting, and a Q-parameterization design step to minimize a robustness measure. Both the D-step and the Q-step are formulated based on frequency gridding optimization. However, it does not incorporate multiple performance design objectives into the iteration. The potential advantage of performing the iteration without D-fitting is not addressed. There is only one sentence in [Lanzon PhD 2000, page 59] “Performance weights and D-scales are found and used pointwise in frequency and hence need not be fitted with stable minimum-phase transfer function matrices”, without actually indicating or showing the benefits of performing the iteration without curve-fitting, as opposed to the publications claimed in the invention [K. Tsai and H. Hindi, “DQIT: μ-synthesis without D-Scale Fitting,” American Control Conference 2002, pp. 493-498] and [K. Tsai, Design of Feedforward and Feedback Controllers by Signal Processing and Convex Optimization Techniques, chapter 2, chapter 3, and page 129-130.] In fact, in [Lanzon CDC1999] it is implied by the author that the frequency-gridding optimization is not the preferred approach. Therefore in [Lanzon CDC2000], a state-space approach is proposed to perform the synthesis without frequency-gridding, and notably the Δ-N-Q formulation is abandoned, and the Δ-P-K formulation is used. Although it claims the new state-space approach can incorporate “other closed-loop objectives such as regional pole placement, H₂ norm minimization, etc”, it is well-known that this is equivalent with the previously-mentioned state-space Hoo control solution using linear matrix inequities, which can easily lead to conservatism where additional constraints on its decision variables are imposed in order to preserve the convexity of the control optimization problem.

### SUMMARY OF INVENTION

A method for design of a multi-objective least conservative robust controller to control a plant or a process which may be modeled imperfectly is disclosed. It comprises a robust analysis step and a robust multi-objective controller synthesis step using Q-parameterization control design technique. The main advantages of this method include: 1. It allows for the tradeoff between multiple time-domain and frequency-domain performance objectives while keeping a robustness measure under a least conservative level; 2. It does not require the designer to provide curve-fitted parametric models for the uncertainty scaling and the uncertainty weight, therefore the potential numerical problems and performance conservatism due to curve-fitting can be avoided.

In one embodiment of the invention, the K-step of standard D-K iteration for mu-synthesis is replaced by a Q-parameterization control design step. The Q-step optimization problem formulation comprises a standard robustness measure and one or a plurality of other performance measures. During the iteration, the Q-step optimization problem formulation can be changed. In another embodiment, a controller satisfying a level of robustness measure is first found. Then, a Q-parameterization control design step is performed, such that one or plurality of the other performance measures are optimized, while still satisfying a level of robustness measure which is the same with, or slightly traded-off from the previous level of robustness measure. In all embodiments of the invention, if the robustness measure in the Q-step is formulated based on frequency-gridding, the problematic D-step curve fitting process in standard D-K iteration can be avoided. In addition, a least-conservative non-parametric plant uncertainty weights can incorporated directly without curve-fitting. Therefore the difficulties of curve-fitting and the conservativeness due to curve-fitting in standard D-K iteration can both be eliminated.

Although many details have been included in the description and the figures, the invention is defined by the scope of the claims. Only limitations found in those claims apply to the invention.

### BRIEF DESCRIPTION OF DRAWINGS

FIG. 1A is a prior-art block-diagram showing the general control problem formulation for a system with modeling uncertainties.

FIG. 1B is a prior-art block-diagram showing the performance uncertainties of a system can be augmented to its modeling uncertainties in the linear robust control framework

FIG. 1C is a prior-art block-diagram showing the use of a block-diagonal scaling D on the A-P-K control problem formulation, to reduce the conservatism of a robustness measure by exploiting the structure of the uncertainty, as in the prior-art D-K iteration method.

FIG. 1D is a prior-art block diagram showing a generalized control design problem with Q-parameterization.

FIG. 1E is a prior-art block showing an equivalent generalized control design problem with FIG. 1D, with Q-parameterization.

FIG. 2A is a block-diagram showing the application of Q-parameterization on the generalized plant model P.

FIG. 2B is a block-diagram showing after Q-parameterization, the new generalized plant model is N, and the new control design parameter is Q.

FIG. 2C is a block-diagram for showing the use of a block-diagonal scaling D on the Δ-N-Q control problem formulation to reduce the conservatism by exploiting the structure of the uncertainty of a robustness measure

FIG. 3 is a prior-art flowchart of the standard D-K iteration method.

FIG. 4 is a control design flowchart as one example of one embodiment of the invention, which enables synthesizing multiple performance objectives by replacing the K step in FIG. 3 of D-K iteration with a Q-step optimization problem formulation, and problem and conservatism due to the curve-fitting of the D-scaling and plant uncertainty weight of D-K iteration can be avoided by formulating the optimization problem based on frequency-gridding.

FIG. 5 is a control design flowchart as one example of another embodiment of the invention, where a controller satisfying a level of robustness measure is first found, followed by a Q-parameterization control design step which optimizes one or multiple design objectives while still closely satisfying the level of robustness measure.

FIG. 6 is a control design flowchart as one example of applying the embodiment shown in FIG. 5 to compare with a prior-art multi-objective control design method without considering the structure of the uncertainty.

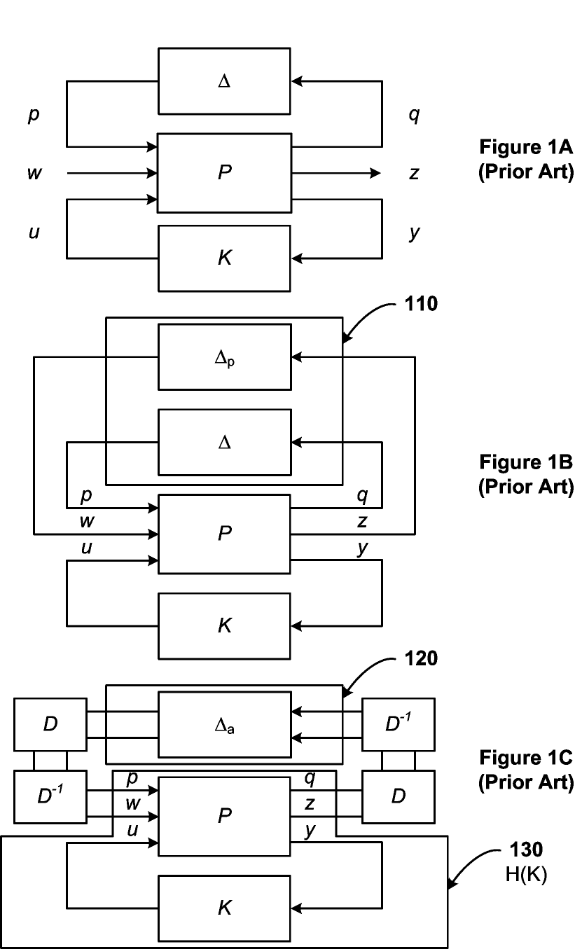

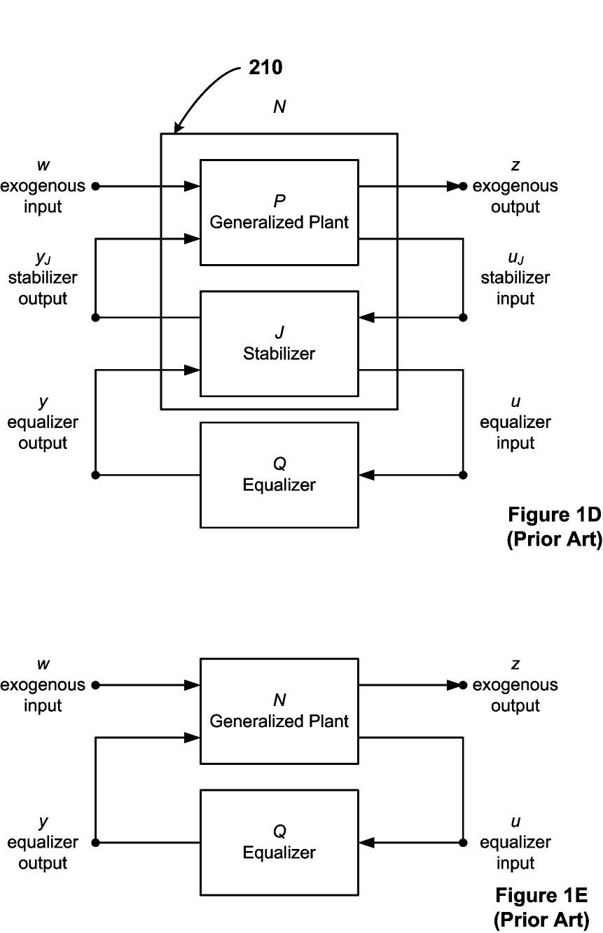

### DETAILED DESCRIPTION

An Overview of an Embodiment of the Invention

A method for fast design of frequency-shaping multi-objective equalizers is disclosed. It comprises a robust analysis step and a robust multi-objective controller synthesis step using Q-parameterization control design technique. In all embodiments of the invention, if the robustness measure in the Q-step is formulated based on frequency-gridding, the problematic D-step curve fitting process in standard D-K iteration can be avoided. In addition, a least-conservative non-parametric plant uncertainty weights can incorporated directly without curve-fitting. Therefore the difficulties of curve-fitting and the conservativeness due to curve-fitting in standard D-K iteration can both be eliminated.

In one embodiment of the invention, the K-step of standard D-K iteration for mu-synthesis is replaced by a Q-parameterization control design step. The Q-step optimization problem formulation comprises a standard robustness measure and one or a plurality of other performance measures. During the iteration, the Q-step optimization problem formulation can be changed. In another embodiment, a controller satisfying a level of robustness measure is first found. Then, a Q-parameterization control design step is performed, such that one or plurality of the other performance measures are optimized, while still satisfying a level of robustness measure which is the same with, or slightly traded-off from the previous level of robustness measure.

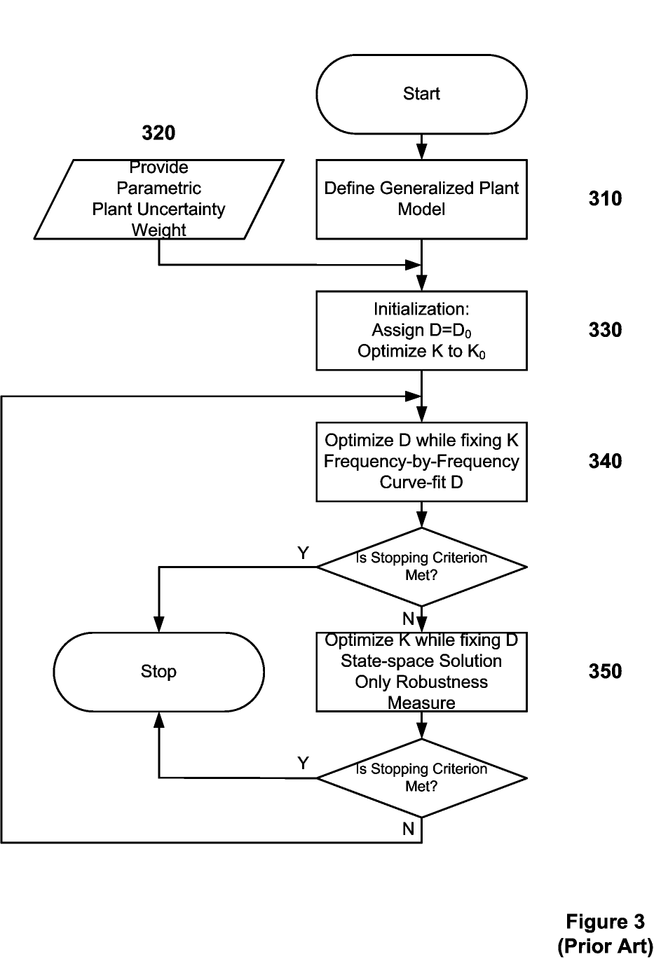

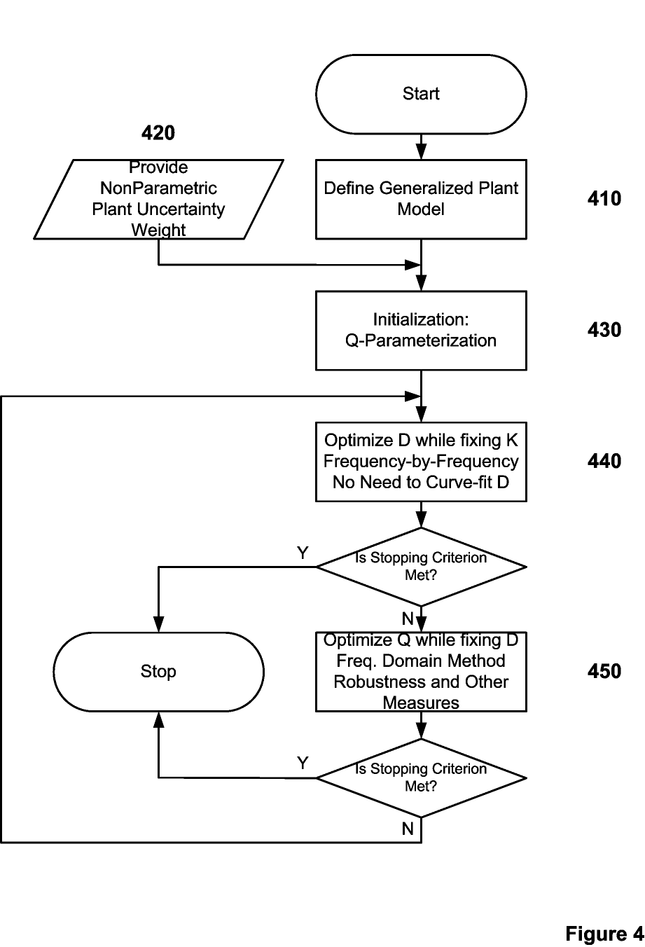

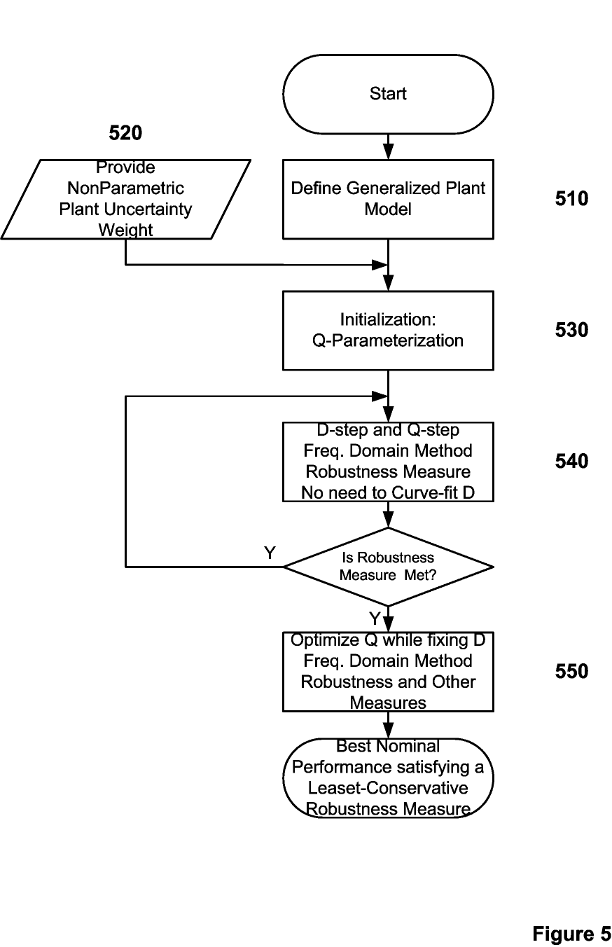

An example design flowchart in FIG. 4 is provided for the first embodiment. Another example design flowchart in FIG. 5 is provided for the second embodiment. Comparing with the prior-art design flow chart in FIG. 3, the design steps that appear in both the prior-art and the invention will only be briefly explained since their details can be found in several prior-art references.

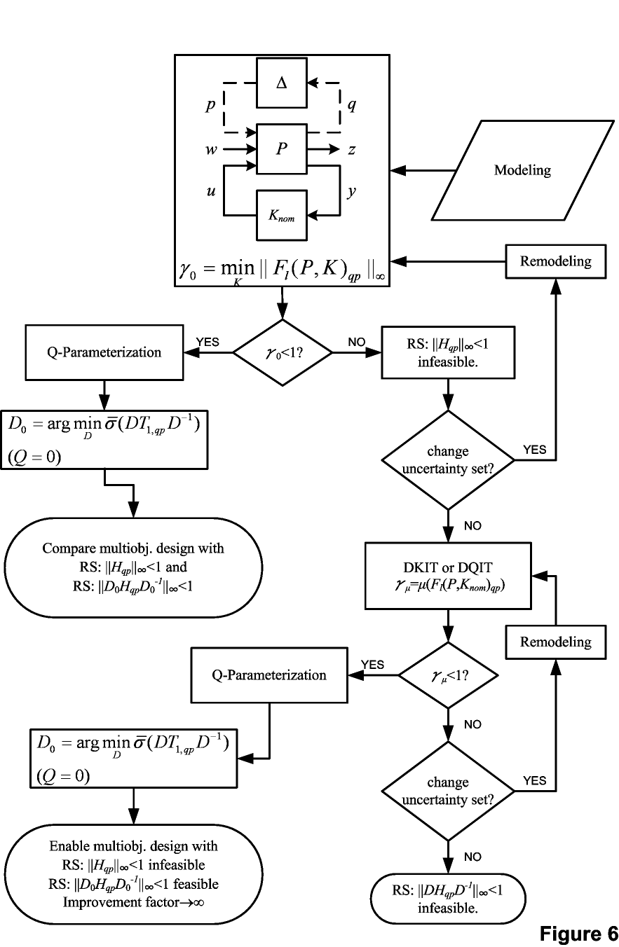

A practical design example following the example design flowchart in FIG. 6 is described to demonstrate the effectiveness of the algorithms disclosed in the invention.

Embedding Nominal Performance Specifications In #-Synthesis

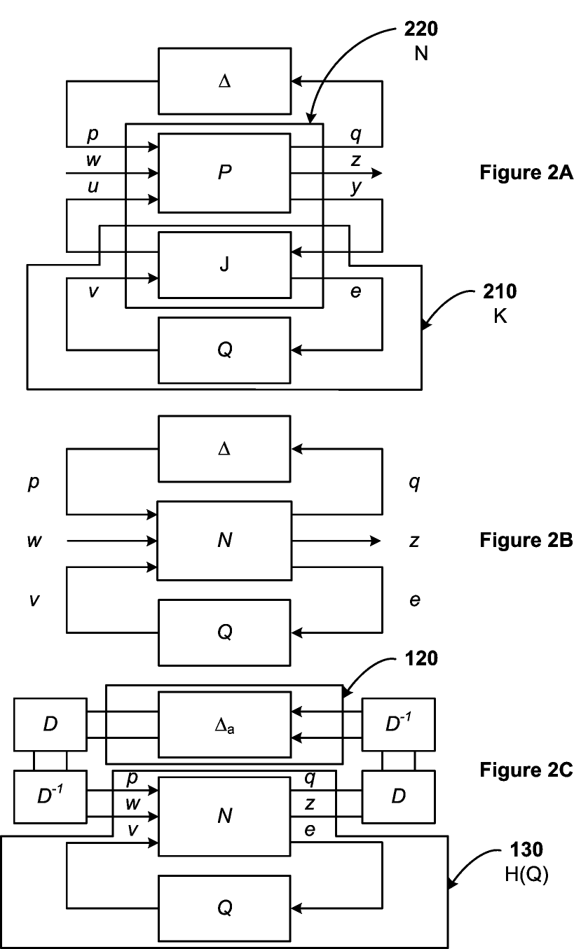

FIG. 4. shows an example design flowchart for one embodiment of the invention, where the control optimization step 450 incorporate standard robustness measure and one or multiple of performance objectives. The method starts with step 410 to define a generalized plant model, as in the prior-art step 310. Then Q-parameterization is performed in step 430, such that the problem formulation is in the form of FIG. 2B and FIG. 2C. Then in step 440, the frequency response of the block-diagonal uncertainty scaling D is optimized frequency-by-frequency, as in the prior-art step 340. If in step 450, the designer chooses the robustness measure to be formulated based on a frequency-by-frequency gridding optimization formulation, then in step 440, no curve-fitting to the frequency response of D is required; and in step 420, the frequency response data of the uncertainty weights can be provided without curve-fitting it to a parametric model. Some prior-art publication explaining the procedure to perform this frequency gridding optimization can be found in [B. Rafaely et al, “H₂/H_{∞} active control of sound in a headrest: design and implementation,” IEEE Trans. Control System Technology, vol. 7, no. 1, January 1999][P. Titterton, “Practical method for constrained-optimization controller design: H₂ or H_{∞} optimization with multiple H and/or H_{∞} constraints,” IEEE Proceedings of ASILO 1996]][A. Lanzon et al “A Frequency Domain Optimisation Algorithm for Simultaneous Design of Performance Weights and Controllers in mu-Synthesis”, Proceedings of the 38th IEEE Conference on Decision and Control, Vol. 5, pp. 4523-4528, Phoenix, Ariz., USA, December 1999] [K. Tsai et al, “DQIT: μ-synthesis without D-Scale Fitting,” American Control Conference 2002, pp. 493-498]. If the robustness measure is formulated based on non-frequency gridding approaches, then parametric models in step 420 and step 440 are still required. In step 450, the control optimization formulation no only include the robustness measure, but also one or multiple performance objectives. The trade-off between these performance objectives and the improvement of the robustness measure can be adjusted by modified the control optimization formulation in each iteration. As an example, a control optimization problem can be formulated as: minimize {(1−rho)*sigma(DH(Q)D⁻¹))+rho*f₀(H(Q))} for a set of selected frequencies, with respective to the free controller design parameter Q, subject to: {fₖ(H(Q))<0} where k is a nonnegative integer. Here H(Q) represents system 130, sigma(DH(Q)D⁻¹)) represents the upper bound of μ as the robustness measure, f₀ is a performance objective such as maximum control effort, fₖ represents one or multiple performance constraints, such as the noise amplification of one of the input-output channels, and rho is a weighting factor between 0 and 1, which can be adjusted at each iteration to enforce the optimization weights more on the robustness measure or the performance objective f₀. Many other variations from this example optimization formulation are possible. The D-step 440 and Q-step 450 are iterated until a decision is made to stop the iteration, commonly when as performance requirement has been met, or when there is no more performance improvement with more iterations.

Reducing Robust Stability Conservatism of Multi-Objective Ontrol

FIG. 5. shows an example design flowchart for another embodiment of the invention, where step 550 shows one or multiple performance objectives can be simultaneously optimized while satisfying a predetermined robustness measure. The method starts with step 510 to define a generalized plant model, as in the prior-art step 310. Then Q-parameterization is performed in step 530, such that the problem formulation is in the form of FIG. 2B and FIG. 2C. In step 540 a Q-step and a D-step iteration is performed until a robustness measure is met. In fact, in one variation step 530 and step 540 can be replaced by the prior-art D-K iteration, followed by a Q-parameterization step before step 550. In step 550, the control optimization formulation includes one or multiple performance objectives or constraints, and the robustness measure intending to keep the level of robustness measure obtained by step 540. As an example, suppose from step 540 an upper bound of μ is found to be gamma0. A control optimization problem can be formulated as: minimize {f (Q)for a set of selected frequencies, with respective to the free controller design parameter Q, subject to {sigma(DH(Q)D⁻¹))<gamma1, and fₖ(Q)<O, k=1, 2, 3 . . . }. Here H(Q) represents system 130, sigma(DH(Q)D⁻¹)) represents the upper bound of μ as the robustness measure, f₀ is a performance objective such as maximum control effort, fₖ represents one or multiple performance constraints, such as the noise amplification of one of the input-output channels, and gamma0 is the same or slightly adjusted to be larger than gamma0 obtained from step 540, such that the optimization process can have enough feasible set in order to satisfy the performance constraints fₖ(Q)<0. Many other variations from this example optimization formulation are possible. This method is useful to improve the conservatism of the previously described prior-art Q-parameterization control design method where the inherent structure of the uncertainties are commonly ignored by simply formulating sigma(H(Q)) which is equivalent with a un-scaled H_{∞} constraint. FIG. 6 shows an example flowchart two compare the method in this embodiment and the prior-art method. Numerical examples can be found in [K. Tsai, Design of Feedforward and Feedback Controllers by Signal Processing and Convex Optimization Techniques, chapter 3], which is claimed for the invention.

If in step 550, the designer chooses to use Q-optimization as in step 530, and formulate the robustness measure based on a frequency-by-frequency gridding optimization formulation, then in the iteration step 540, no curve-fitting to the frequency response of D is required; and in step 520, the frequency response data of the uncertainty weights can be provided without curve-fitting it to a parametric model. Some prior-art publication explaining the procedure to perform this frequency gridding optimization can be found in [B. Rafaely et al, “H₂/H_{∞} active control of sound in a headrest: design and implementation,” IEEE Trans. Control System Technology, vol. 7, no. 1, January 1999][P. Titterton, “Practical method for constrained-optimization controller design: H₂ or H_{∞} optimization with multiple H₂ and/or H_{∞} constraints,” IEEE Proceedings of ASILO 1996]][A. Lanzon et al “A Frequency Domain Optimisation Algorithm for Simultaneous Design of Performance Weights and Controllers in mu-Synthesis”, Proceedings of the 38th IEEE Conference on Decision and Control, Vol. 5, pp. 4523-4528, Phoenix, Ariz., USA, Dec 1999] [K. Tsai et al, “DQIT: μ-synthesis without D-Scale Fitting,” American Control Conference 2002, pp. 493-498]. If the robustness measure is formulated based on non-frequency gridding approaches, then parametric models in step 520 and step 540 are still required.

D-Q Iteration with Nonparametric Plant Uncertainty Weights Incorporated Directly without Curve-Fitting

As another embodiment, when there is no need to incorporated multiple performance objectives with a robustness measure, but it is desired to reduce the conservatism by reducing the modeling error of the plant uncertainty from its experimental data, step 450 can be substituted with “Optimize Q while fixing D, based on frequency gridding to formulate robustness measures, with or without other performance measures”. In step 420, the frequency response of the plant uncertainty can be provided directly from a estimate of the least conservative nonparametric model error weight. One of the prior-art publications showing a method to perform the estimation is [H. Hindi et al, “Identification of Optimal Uncertainty Models from Frequency Domain Data,” Proceedings of the IEEE Conference on Decision and Control, 2002]. It should reduce the conservatism due to the use of a simplified and conservative model error weighting function of the standard D-K iteration.

D-Q Iteration with Robustness Measure Formulated with Decision Variables Being The Frequency Response of Q

When formulating a robustness measure based on frequency-gridding optimization, it is common practice to use the coefficients of the free controller design parameter Q as the decision variables, and the robustness measure objectives or constraints are specified frequency-by-frequency with respect to the frequency response of Q. The frequency response and the coefficients of the free controller design parameter Q can be related by a discrete Fourier transform relationship. However, there are cases where it is preferred to formulate the optimization problem in terms of the frequency response of Q directly. One example can be found in [B. Boulet et al An LMI Approach to IMC-Based Robust Tunable Control, American Control Conference 2003, pp 821]. However, the frequency response of Q can not be optimized independently without any constraints, because its inverse discrete Fourier transform may not be periodically causal, which can cause problems when implementing the Q filter. Periodically causality is a property of discrete signals which is explained in [V. Oppenheim et al, Discrete-Time Signal Processing, Prentice Hall, 1989]. The invention discloses a method to impose periodical causality on the frequency response of Q. The method is to use Hilbert Transform to relate the real part and imaginary part of the frequency response of Q at each of a selected set of frequencies. One example of the mathematical formulation is found in [K. Tsai and H. Hindi, “DQIT: μ-synthesis without D-Scale Fitting,” American Control Conference 2002, pp. 493-498] which is claimed for the invention.

With this optimization formulation, another embodiment to improve the prior-art D-K iteration in FIG. 3 is to substitute step 450 with “Optimize Q while fixing D, based on frequency gridding to formulate robustness measures, with or without other performance measures” and the frequency gridding formulation is based using the frequency response of the free controller design parameter Q as the decision variables, with periodical causality constraints imposed on the decision variables.

A Comparison of D-K Iteration with D-Q Iteration without D-fitting

TABLE 1
Comparisons of DKIT and DQIT, ωₗ = 2π · 1 rad/s

| Iteration | 1 | 2 | 3 | 4 | 5 |
|---|---|---|---|---|---|
| K order | 6 | 10 | 10 | 10 | 10 |
| total D order | 0 | 4 | 4 | 4 | 4 |
| μₘₐₓ (DKIT) | 28.10 | 18.99 | 16.26 | 14.93 | 14.32 |
| μₘₐₓ (DQIT) | 31.66 | 6.78 | 3.55 | 3.14 | 3.13 |

Table 1 shows a numerical example for the advantage of using D-Q iteration versus the standard prior-art implementation of D-K iteration. In order to make a one-to-one comparison, the control design optimization formulation in step 450 comprises only a robustness measure, which the upper bound of μ. It shows that both D-K iteration and D-Q iteration can reduce the upper bound of μ monotonically. However, in D-K iteration, to avoid numerical conditioning problems during the D-scale fitting, a lower fitting order has to be used, thus μ converges slowly at about 14, comparing to the monotonic decrease of μ down to 3.13 with D-Q iteration without D-scaling fitting. The details of this numerical example is described in [K. Tsai et al, “DQIT: μ-synthesis without D-Scale Fitting,” American Control Conference 2002, pp. 493-498] which is claimed for the invention.

1. A method to synthesize a robust controller to control a process of the type which may be modeled imperfectly, said method comprising:
a. providing an generalized plant model as in a prior-art D-K iteration method for synthesizing robust controllers, said generalized plant model comprising a nominal plant model, one or a plurality of selected perturbation weightings, one or a plurality of selected performance weightings, input ports for perturbation input, exogenous input, control input, and output ports for perturbation output, exogenous output, control output, said control input and said control output corresponding to a controller to be designed;
b. providing a convex closed-loop map by applying a parameterization method on said generalized plant model, said convex closed-loop map being convex in terms of a free controller design parameter; said convex closed-loop map having a plurality of input channels corresponding to the exogenous input and the perturbation output of said generalized plant model, said convex closed-loop map having a plurality of output channels corresponding to the exogenous output and the perturbation input of said generalized plant model, said free controller design parameter being a stable system;
c. providing a means for optimizing a robust scaling for a robustness measure relating to said convex closed-loop map, while holding said free controller design parameter fixed, said robust scaling corresponding to the robust scaling of said prior-art D-K iteration method, said robustness measure corresponding to a robustness measure of said prior-art D-K iteration method;
d. computing said free controller design parameter by formulating a controller optimization problem while holding said robust scaling fixed, said controller optimization problem relating to said robustness measure and some other measure of said closed-loop map;
e. iterating step c and step d until a stopping criterion is satisfied.

2. The method in claim 1 wherein the frequency response of said robust scaling is optimized on a set of selected frequencies, said convex control optimization problem formulates said robustness measure on a number of said set of selected frequencies, based on a selected frequency gridding.

3. The method in claim 1 wherein said perturbation weighting is provided directly from a nonparametric estimate of the modeling uncertainty of said nominal plant model on a finite number of selected frequencies.

4. The method in claim 1 wherein said convex control optimization problem formulates said robustness measure on a set of selected frequencies based on frequency gridding, the decision variables of said controller optimization problem are the frequency response of said free controller design parameter on said set of selected frequencies, the inverse discrete Fourier transform of said frequency response is constrained to be periodically stable.

5. The method in claim 1 wherein said convex control optimization problem formulates said robustness measure on a set of selected frequencies based on frequency gridding, the decision variables of said controller optimization problem are the coefficients of said free controller design parameter on said set of selected frequencies.

6. The method in claim 1 wherein said controller optimization problem are changed during said iteration in step e.

7. The method in claim 1 wherein said parameterization method relates to Youla-parameterization.

8. A method to synthesize a robust controller to control a process of the type which may be modeled imperfectly, said method comprising:
a. providing an generalized plant model as in a prior-art D-K iteration method for synthesizing robust controllers, said generalized plant model comprising a nominal plant model, one or a plurality of selected perturbation weightings, one or a plurality of selected performance weightings, input ports for perturbation input, exogenous input, control input, and output ports for perturbation output, exogenous output, control output, said control input and said control output corresponding to a controller to be designed;
b. providing a convex closed-loop map by applying a parameterization method on said generalized plant model, said convex closed-loop map being convex in terms of afreecontroller design parameter; said convex closed-loop map having a plurality of input channels corresponding to the exogenous input and the perturbation output of said generalized plant model, said convex closed-loop map having a plurality of output channels corresponding to the exogenous output and the perturbation input of said generalized plant model, said free controller design parameter being a stable system;
c. providing a means for finding a robust scaling such that a robustness measure achieves a robustness level, said robust scaling corresponding to the robust scaling of said prior-art D-K iteration method, said robustness measure corresponding to a robustness measure of said prior-art D-K iteration method;
d. computing said free controller design parameter by formulating a controller optimization problem while holding said robust scaling fixed, said control optimization problem relating to said robustness measure, said robustness level, and some other measure of said closed-loop map;

9. The method in claim 8 wherein the frequency response of said robust scaling is optimized on a set of selected frequencies, said convex control optimization problem formulates said robustness measure on a number of said set of selected frequencies, based on a selected frequency gridding.

10. The method in claim 8 wherein said perturbation weighting is provide directly from a nonparametric estimate of the modeling uncertainty of said nominal plant model on a finite number of selected frequencies.

11. The method in claim 8 wherein said convex control optimization problem formulates said robustness measure on a set of selected frequencies based on frequency gridding, the decision variables of said controller optimization problem are the frequency response of said free controller design parameter on said set of selected frequencies, the inverse discrete Fourier transform of said frequency response is constrained to be periodically stable.

12. The method in claim 8 wherein said convex control optimization problem formulates said robustness measure on a set of selected frequencies based on frequency gridding, the decision variables of said controller optimization problem are the coefficients of said free controller design parameter on said set of selected frequencies.

13. The method in claim 8 wherein said parameterization method relates to Youla-parameterization.

14. The method in claim 8 wherein said means for finding said robust scaling involves with a direct search based on gridding of the parameter space of said robust scaling.

15. The method in claim 8 wherein step c said means for finding said robust scaling comprises:
a. providing a means for optimizing a robust scaling for said robustness measure relating to said convex closed-loop map, while holding said free controller design parameter fixed;
b. computing said free controller design parameter by formulating a controller optimization problem while holding said robust scaling fixed, said controller optimization problem relating to said robustness measure;
c. iterating step a and step b until a stopping criterion is satisfied.

16. The method in claim 8 wherein step d at least one input-output channel relating to said some other measure of said closed-loop map is included in said robustness measure;

17. The method in claim 8 wherein step d all the input-output channels relating to said some other measure of said closed-loop map, and all the input-output channels of said robustness measure, are different.

18. A method to synthesize a robust controller to control a process of the type which may be modeled imperfectly, said method comprising:
a. providing an generalized plant model as in a prior-art D-K iteration method for synthesizing robust controllers, said generalized plant model comprising a nominal plant model, one or a plurality of selected perturbation weightings, one or a plurality of selected performance weightings, input ports for perturbation input, exogenous input, control input, and output ports for perturbation output, exogenous output, control output, said control input and said control output corresponding to a controller to be designed, said perturbation weighting is provide directly from a nonparametric estimate of the modeling uncertainty of said nominal plant model on a finite number of selected frequencies;
b. providing a convex closed-loop map by applying a parameterization method on said generalized plant model, said convex closed-loop map being convex in terms of a free controller design parameter; said convex closed-loop map having a plurality of input channels corresponding to the exogenous input and the perturbation output of said generalized plant model, said convex closed-loop map having a plurality of output channels corresponding to the exogenous output and the perturbation input of said generalized plant model, said free controller design parameter being a stable system;
c. providing a means for optimizing a robust scaling for a robustness measure relating to said convex closed-loop map, while holding said free controller design parameter fixed, said robust scaling corresponding to the robust scaling of said prior-art D-K iteration method, said robustness measure corresponding to a robustness measure of said prior-art D-K iteration method;
d. computing said free controller design parameter by formulating a controller optimization problem while holding said robust scaling fixed, said controller optimization problem relating to said robustness measure;
e. iterating step c and step d until a stopping criterion is satisfied.

19. A method to synthesize a robust controller to control a process of the type which may be modeled imperfectly, said method comprising:
a. providing an generalized plant model as in aprior-art D-K iteration method for synthesizing robust controllers, said generalized plant model comprising a nominal plant model, one or a plurality of selected perturbation weightings, one or a plurality of selected performance weightings, input ports for perturbation input, exogenous input, control input, and output ports for perturbation output, exogenous output, control output, said control input and said control output corresponding to a controller to be designed;
b. providing a convex closed-loop map by applying a parameterization method on said generalized plant model, said convex closed-loop map being convex in terms of a free controller design parameter; said convex closed-loop map having a plurality of input channels corresponding to the exogenous input and the perturbation output of said generalized plant model, said convex closed-loop map having a plurality of output channels corresponding to the exogenous output and the perturbation input of said generalized plant model, said free controller design parameter being a stable system;
c. providing a means for optimizing a robust scaling for a robustness measure relating to said convex closed-loop map, while holding said free controller design parameter fixed, said robust scaling corresponding to the robust scaling of said prior-art D-K iteration method, said robustness measure corresponding to a robustness measure of said prior-art D-K iteration method;
d. computing said free controller design parameter by formulating a controller optimization problem while holding said robust scaling fixed, said controller optimization problem relating to said robustness measure, said convex control optimization problem formulates said robustness measure on a set of selected frequencies based on frequency gridding, the decision variables of said controller optimization problem are the frequency response of said free controller design parameter on said set of selected frequencies, the inverse discrete Fourier transform of said frequency response is constrained to be periodically stable;
e. iterating step c and step d until a stopping criterion is satisfied.
